(19) United States
(12) Patent Application Publication
(10) Pub. No.: US 2024/0365825 A1
(43) Pub. Date: Nov. 7, 2024

(54) FOOD PRODUCTS CONSUMABLE WHILE FASTING AND METHODS OF MAKING SAME

(71) Applicants: Marius F. IRIMIES, Blacklick, OH (US); Jason V. SHUGART, Dayton, OH (US)

(72) Inventors: Marius F. IRIMIES, Blacklick, OH (US); Jason V. SHUGART, Dayton, OH (US)

(21) Appl. No.: 18/654,625

(22) Filed: May 3, 2024

Related U.S. Application Data
(60) Provisional application No. 63/500,321, filed on May 5, 2023.

(51) Int. Cl. A23L 21/10; A23L 5/10; A23L 27/30; A23L 29/256; A23P 30/38

(52) U.S. Cl. CPC A23L 21/10; A23L 5/11; A23L 5/17; A23L 27/33; A23L 29/256; A23P 30/38

(57) ABSTRACT

Food products that have enough flavor to be desirable and a psychological effect to enable longer fasting periods without the physiological effects of increased insulin production and increased blood glucose and without interrupting the metabolic processes of lipolysis or ketosis are described herein. The food products are a gelled food product, a dehydrated gelled food product, and a crisp formed from a dehydrated gelled food product. Methods of making such food products are also described herein. The food products can include agar-agar.

### RELATED APPLICATIONS

This application claims the benefit of U.S. Provisional Application No. 63/500,321, filed May 5, 2023, which is herein incorporated by reference in its entirety.

### FIELD OF THE INVENTION

The present invention relates generally to food products, and more particularly to food products for consumption during fasting that include a thickening agent in a suitable liquid, a sweetener, a flavoring, and optional additives, none of which in combination will trigger an insulin spike or increased blood glucose levels upon consumption.

### BACKGROUND OF THE INVENTION

Insulin resistance is the single most significant metabolic issue causing the global rise in obesity. Insulin resistance arises from a reduced sensitivity of cells to insulin, even though the body is producing enough insulin, which can lead to a range of metabolic disorders, including type 2 diabetes, cardiovascular disease, non-alcoholic fatty liver disease, Alzheimer's, kidney failure, and autoimmune conditions, among others. Insulin resistance has also been linked to chronic inflammation including many forms of arthritis, oxidative stress, and disturbances in cellular and neural signaling pathways. The condition is thought to be driven by a complex interplay of genetic and environmental factors, including dietary habits, physical inactivity, and other lifestyle factors. As such, understanding the underlying mechanisms that contribute to insulin resistance remains a critical area of research. Developing effective interventions for preventing and treating insulin resistance is crucial for mitigating the adverse health outcomes associated with the condition.

Insulin resistance will develop with frequent nutrient consumption, which leads to prolonged periods of elevated insulin levels. When nutrients are consumed too frequently, cells in the body become less responsive to insulin, further increasing insulin resistance in the cells. This reduced sensitivity can also lead to a state of chronic hyperinsulinemia, where insulin levels remain elevated even during periods of fasting or low nutrient availability. This state can further exacerbate insulin resistance, as cells become desensitized to high insulin levels over time. Consequently, increasing the time periods between nutrient consumption helps to restore normal insulin sensitivity and glucose metabolism, thereby reducing the risk of most metabolic disorders associated with insulin resistance.

Thus, a solution is needed to help decrease obesity and reduce insulin resistance in individuals and even pets, especially dogs and cats.

### SUMMARY

In all aspects, a chewable food product is disclosed that has enough flavor to be desirable and a psychological effect to enable longer fasting periods without the physiological effects of increased insulin production and increased blood glucose and without interrupting the metabolic processes of lipolysis or ketosis. The premise for this invention was to create a food product that would have zero to minimal impact on insulin secretion; have a desirable taste; provide the desired psychological and physiological effects; and not interrupt ketosis.

In one aspect, food products are disclosed in a dehydrated form that has a water content of 30% w/w to 45% w/w thereof, wherein the dehydrated form is formed from a gelled food precursor comprising 1 g to 40 g of a thickening agent per liter of water, a sweetener, a medium chain triglyceride oil, and a flavoring, wherein the thickening agent, sweetener, water, and flavoring do not produce an insulin spike or increased blood glucose level upon consumption. In any of the embodiments, the thickening agent is selected from the group consisting of agar-agar, Kanten, locust bean gum, Xanthan gum, gum Arabic, acacia gum, konjac, pectin, alginate, arabinoxylan, cassia gum, cellulose, arrowroot, kudzu, marshmallow root, beta-glucan, curdlan, and combinations thereof. In some embodiments, the thickening agent includes or is agar-agar. In any of the embodiments, the sweetener is a natural sweetener selected from the group consisting of monk fruit sweetener, stevia, erythritol, xylitol, sorbitol, and combinations thereof. In any of the embodiments, the medium chain triglyceride oil is present as 1% w/w to 6% w/w of the gelled food precursor. Optionally, the food product includes an edible preservative.

In another aspect, a food products are disclosed that have a puffed or popped form. The food product has a gelled food precursor that is dehydrated to form a gelled food precursor comprising water as 10% w/w or less thereof. The which gelled food precursor had 1 g to 40 g of a thickening agent per liter of water, baking soda, and a flavoring, none of which produce an insulin spike or increased blood glucose level upon consumption. In any of the embodiments, the thickening agent is selected from the group consisting of agar-agar, Kanten, locust bean gum, Xanthan gum, gum Arabic, acacia gum, konjac, pectin, alginate, arabinoxylan, cassia gum, cellulose, arrowroot, kudzu, marshmallow root, beta-glucan, curdlan, and combinations thereof. In some embodiments, the thickening agent includes or is agar-agar. Optionally, the food product includes an edible preservative. The puffed or popped form is a fried-in-oil form of the gelled food product or an air fried form of the gelled food product.

In yet another aspect, methods of making food products are disclosed that include providing a gelled food product as described herein; and removing water from the gelled food product to form a partially dehydrated food product comprising a water content of 30% w/w to 45% w/w thereof. In some embodiments, removing water occurs in maximum of 10 hours and includes placing the gelled food product in a dehydrator at a temperature of 60° C. to 77° C.

In another aspect of a method of making food products, the method includes providing a gelled food product as described herein, removing water from the gelled food product to form a dehydrated food product having a water content 10% w/w or less thereof, and puffing or popping the dehydrated food product to form a crisp food product. In one embodiment, puffing or popping comprises frying in an oil, and the oil can be selected form the group consisting of coconut oil, olive oil, avocado oil, and pumpkin seed oil. The frying in oil can be followed by secondarily dehydrating the crisp food product. In another embodiment, puffing or popping comprises air frying the dehydrated food form.

These and other aspects, objects, features and advantages of the example embodiments will become apparent to those having ordinary skill in the art upon consideration of the following detailed description of illustrated example embodiments.

### BRIEF DESCRIPTION OF THE DRAWINGS

The patent or application file contains at least one drawing executed in color. Copies of this patent or patent application publication with color drawing(s) will be provided by the Office upon request and payment of necessary fec.

FIG. 1 is photograph of a chewable gelled-food product in set form in a cup-shaped mold.

FIG. 2 is a photograph of a chewable gelled-food product after removal from the cup-shaped mold of FIG. 1.

FIG. 3 is a photograph of a chewable gelled-food product in dot-shaped forms in multiple flavors.

FIG. 4 is a photograph of a chewable food product that has a brownie-like texture while sweetener crystals on the exterior surface thereof.

FIG. 5 is a photograph of a chewable food product that has a brownie-like texture with minimal sweetener crystals on the exterior surface thereof.

FIG. 6 is a photograph of a chewable food product that has a brownie-like texture without sweetener crystals on the exterior surface thereof.

FIG. 7 is a photograph of chewable food product in crisp form.

FIG. 8 is a flow chart of photographs taken during a puffing process for a dehydrated food product embodiment.

FIG. 9 is a photograph of a plate of the final crisps from the process shown in FIG. 8.

### DETAILED DESCRIPTION

The following description and drawings are illustrative and are not to be construed as limiting. Numerous specific details are described to provide a thorough understanding of the disclosure. In certain instances, however, well-known or conventional details are not described to avoid obscuring the description. References to one or an embodiment in the present disclosure can be, but not necessarily, are references to the same embodiment; and, such references mean at least one of the embodiments.

Unless otherwise noted, technical terms are used according to conventional usage. As used herein, the singular forms “a,” “an,” and “the,” refer to both the singular as well as plural, unless the context clearly indicates otherwise. The abbreviation, “e.g.,” is derived from the Latin exempli gratia, which is synonymous with “for example”, and is used herein to indicate a non-limiting example. As used herein, the term “comprises” means “includes.” All publications, patent applications, patents, and other references mentioned herein are expressly incorporated herein by reference in their entirety.

As used herein, relative terms, such as “substantially,” “generally,” “approximately,” “about,” and the like are used herein to represent an inherent degree of uncertainty that can be attributed to any quantitative comparison, value, measurement, or other representation. These terms are also utilized herein to represent the degree by which a quantitative representation can vary from a stated reference without resulting in a change in the basic function of the subject matter at issue. In certain example embodiments, the term “about” is understood as within a range of normal tolerance in the art for a given measurement, for example, such as within 2 standard deviations of the mean. In certain example embodiments, depending on the measurement “about” can be understood as within 10%, 5%, 1%, 0.5%, 0.1%, 0.05%, or 0.01% of the stated value. Unless otherwise clear from context, all numerical values provided herein can be modified by the term “about.” “Substantially free” as used herein means 1%, 0.5%, 0.1%, 0.05%, or 0.01% or less including zero, and “free” means zero or no measurable, detectable amount.

Fasting can help return insulin levels to normal by reducing the body's insulin demand. During fasting, the body depletes most of the body's glucose stores, thereby lowering cellular glucose. With no nutrient consumption, there is no stimulation of insulin for extended periods, which allows the cells to reduce insulin resistance levels. Additionally, fasting has been shown to stimulate the production of adiponectin, a hormone that promotes insulin sensitivity and glucose uptake in the body. These effects can help restore insulin sensitivity, leading to improved glucose metabolism and reduced risk for metabolic disorders.

Intermittent fasting (generally considered less than 24 hour fasting) has been shown to be a solution to reverse insulin resistance, but this process can take many months or years. Plus, the enhanced benefits of chaperone-mediated autophagy are minimal at best when a human fasts for less than 40 hours. Extended fasting with no nutrient consumption is an accelerated solution to reverse insulin resistance with superior and faster results when done correctly. Most people encounter difficulties when trying to fast for more than two days because people are programmed to eat multiple times per day. However, the smallest bite of food can immediately spike insulin, interrupt ketosis, and turn off chaperone-mediated autophagy.

During no-nutrient fasting, cravings develop due to changes in hormonal and neural signaling pathways. As the body's energy stores are depleted during fasting, levels of the hormone ghrelin increase, which stimulates hunger and food-seeking behaviors. Additionally, levels of leptin, a hormone that regulates appetite and energy expenditure, decrease during fasting, further promoting hunger and food cravings. The brain's reward centers may also become activated during fasting, leading to cravings for high-calorie foods. These effects may be particularly pronounced during extended periods of fasting, which can lead to a heightened sense of deprivation and a greater likelihood of overeating once food becomes available.

Thus, a solution is needed to enable longer fasting periods without interrupting the increased metabolic functions of ketosis and autophagy while simultaneously satisfying the hunger cravings. A chewable food item that can satisfy the hunger craving, i.e., that meets the psychological benefit of consuming food, such as chewing, without stimulating insulin or increasing blood glucose levels, which also does not interrupt the metabolic processes of lipolysis or ketosis is needed.

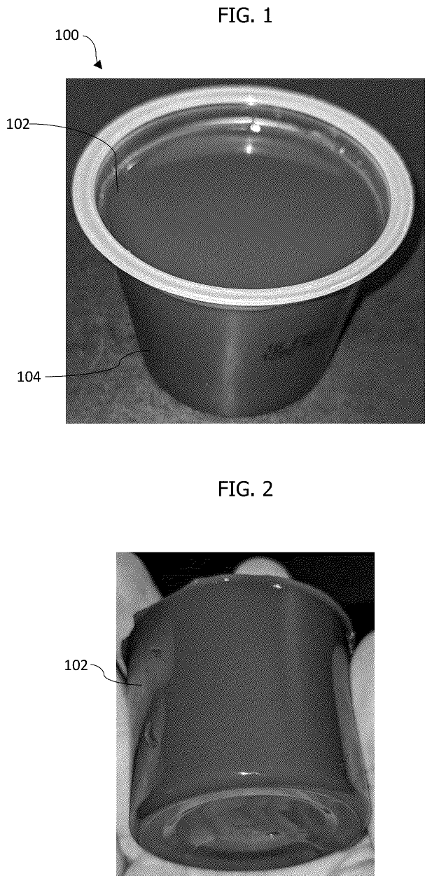

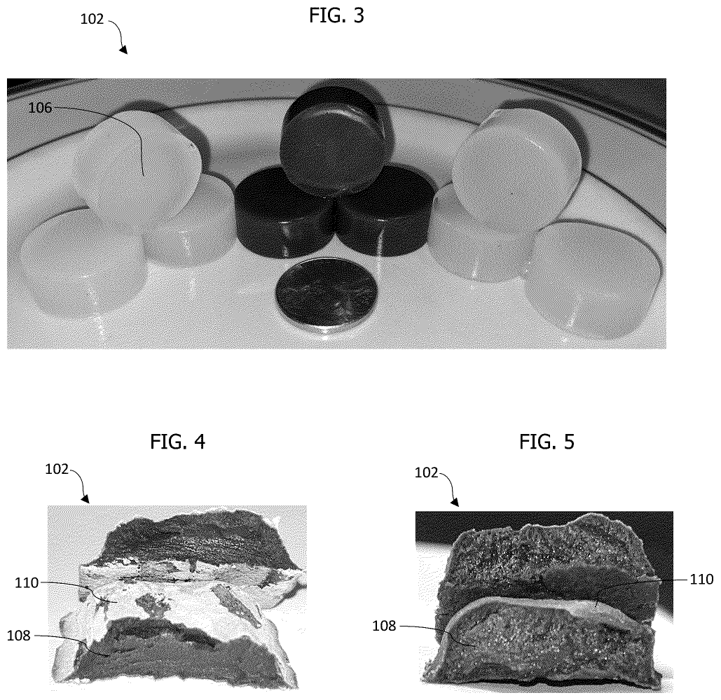

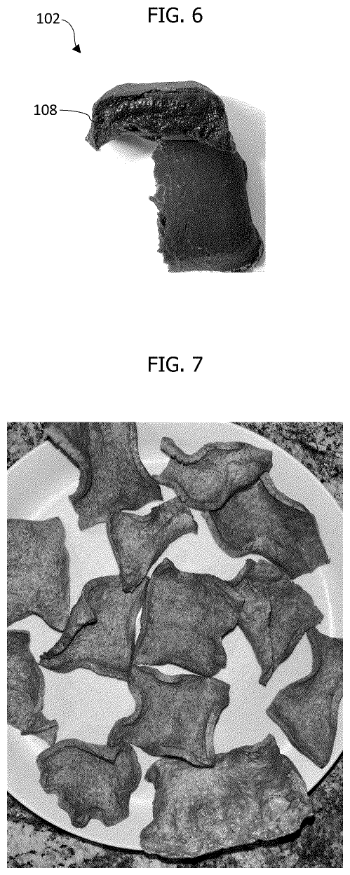

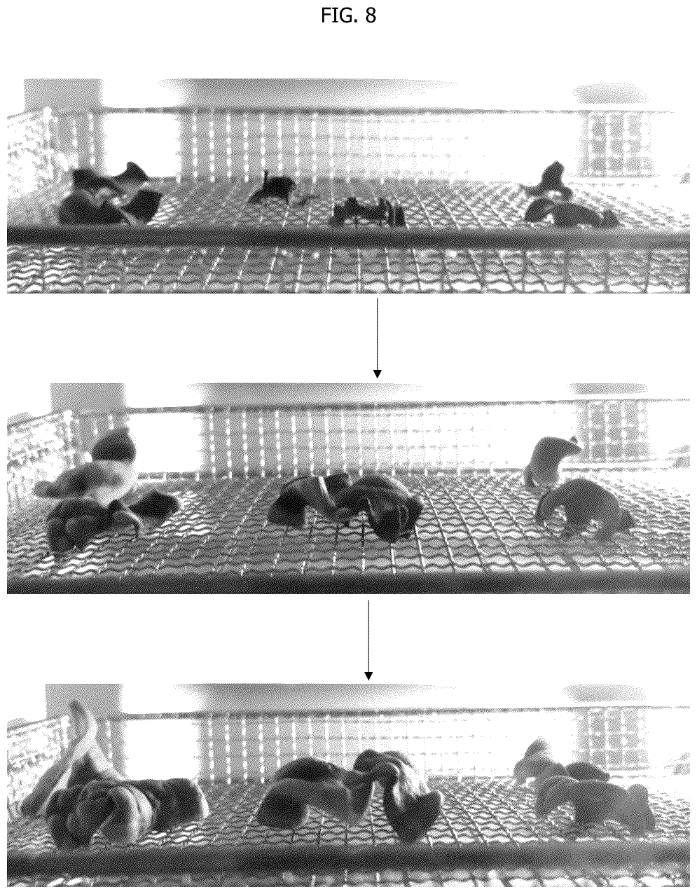

FIGS. 1 to 8 are photographs of an edible food in various forms. FIG. 1 is a food cup 100 of a gelled food 102 molded in a cup 104. FIG. 2 is the gelled food of FIG. 1 after being removed from the cup of FIG. 1. The gelled food 102 maintains the shape of the cup even after being removed therefrom. The edible food of FIGS. 1 and 2 resembles a very thick pudding or finger JELLO®. FIG. 3 is the gelled food 102 in bite-size molded shapes. The shapes are referred to as “dots” herein. The dots 106 in FIG. 3 have a diameter similar to a nickel (5 cent piece) and have a thickness in a range of ¼ in to 2 inches, more preferable ¼ in to 1 in. FIGS. 4-6 are dehydrated forms 108 of the edible food product 102. The dehydrated form 108 of FIG. 4 has crystallized sweetener 110 covering the exterior surface. The dehydrated form 108 of FIG. 5 has minimal sweetener 110 at the exterior surface, and the dehydrated form 108 of FIG. 6 has no sweetener crystallized at the exterior surface thereof. These dehydrated forms have a brownie-like texture. The gelled food 102 of FIG. 8 has been dehydrated and then fried in oil to form a crisp 112. The crisps have less than 10% water, more preferably less than 6% to 8% water.

Each of the edible foods of FIGS. 1 to 8, regardless of form, comprises ingredients that do not stimulate insulin or increase blood glucose levels. Such foods are highly suitable for consumption by individuals during fasting because the foods do not interrupt the metabolic process of lipolysis or ketosis. The foods have minimal impact on chaperone-mediated autophagy and do not trigger hormones or neurotransmitters that interrupt ketosis as demonstrated by a continuous increase in ketones during no-nutrient fasting while consuming the foods. The foods are a healthy snack for all and can be consumed without fasting.

### Thickening Agent

Turning to FIGS. 1 and 2, the gelled food 102 includes a thickening agent, water, and a flavoring, none of which will stimulate insulin, increase blood glucose levels, or increase insulin resistance. The thickening agent is selected from the group consisting of agar-agar, Kanten, locust bean gum, Xanthan gum, gum Arabic, acacia gum, konjac, pectin, alginate, arabinoxylan, cassia gum, cellulose, arrowroot, kudzu (kuzu), marshmallow root, beta-glucan, curdlan. The preferred embodiment is agar-agar, a galactose polymer extracted from red algae.

The thickening agent is free of or substantially free of carrageenan because it increases insulin resistance. Carrageenan has been found to negatively affect insulin resistance by impairing glucose tolerance and inhibiting insulin signaling in vivo in mouse liver and human HepG2 cells. Research indicates that these effects may result from carrageenan-induced inflammation. Inflammation induced by carrageenan may activate inflammatory pathways, such as NF-κB, that can lead to the production of cytokines and chemokines that promote insulin resistance. Additionally, carrageenan-induced inflammation may increase oxidative stress, which can further contribute to insulin resistance. Overall, carrageenan's negative effects on insulin resistance may have implications for the development of metabolic disorders, such as type 2 diabetes. The thickening agent is free of or substantially free of karaya gum because it has a laxative effect and may affect insulin resistance. The thickening agent is free of or substantially free of guar gum and gellan gum, individually or in combination. Guar gum inhibits chaperone-mediated autophagy and gellan gum can increase insulin resistance.

Additionally, the thickening agent is free of or substantially free of any and all starches. Starch is a complex carbohydrate, the most potent nutrient for insulin release. The thickening agent is free of any and all gelatin or other animal proteins, typically derived from collagen. Animal proteins in low concentrations will stimulate mTOR (mammalian target of rapamycin), which in turn interrupts ketosis and more importantly prevents chaperone-mediated autophagy.

The thickening agent is present in the food composition in a range of 1 g to 40 g per liter of water. In one embodiment, the thickening agent is present in a range of 1.4 g to 24 g per liter of water. In another embodiment, the thickening agent is present in a range of 7 g to 14 g per liter of water. For the “wet” gelled food, the thickening agent is preferably present in a range of 7 g to 10 g per liter of water. For the dehydrated gelled food, the thickening agent is preferably present in a range of 7 g to 14 g per liter of water. For the dehydrated and then fried gelled food (crisps), the thickening agent can be in a range of 12 g to 20 g per liter of water.

The water in the edible food products may be pure water (i.e., 100% water) or a water-based liquid. The water in all embodiments can be filtered water, distilled water, purified water, spring water, or mineral water. The water-based liquids can be cactus water, caffeinated coffee, decaffeinated coffee, flavored water, teas, tea infusions, coconut water, etc., and mixtures thereof, so long as it will not spike insulin or interfere with ketosis when consumed. Water-based liquids that include sugars cannot be used herein, such as juice, alcoholic beverages, energy drinks, milk, sodas, nut milk, coconut milk, cider, sports drinks, etc.

### Sweetener

A sweetener is present, preferably a natural sweetener, which does not stimulate insulin or increase blood glucose levels. One example of a natural sweetener is monk fruit sweetener. Monk fruit sweetener is a natural, zero-calorie sweetener that is high in unique antioxidants called mogrosides, which make it 100-250 times sweeter than regular sugar. The monk fruit sweetener can include inulin and/or erythritol to reduce the intensity of the sweetness. Another example of a natural sweetener is Stevia, which is extracted from the leaves of Stevia rebaudiana. Natural sugar alcohols, for example, erythritol, sorbitol, maltitol, lactitol, mannitol, xylitol and combinations thereof, can be used as a sweetener as long as the concentration is below an amount that would produce a laxative effect in the consumer.

The sweetener is present in the food product in a range of 3 g to 100 g per 250 ml product. In one embodiment, the amount of sweetener is in a range of 10 g to 80 g per 250 ml of product. In yet another embodiment, the amount of sweetener is in a range of 15 g to 45 g per 250 ml of product.

### Flavoring

Flavoring options are generally unlimited as long as the flavoring agent does not cause an insulin spike or increase blood glucose levels. Examples flavors include, but are not limited to, orange, mango, raspberry, strawberry, chocolate vanilla, chocolate caramel, peppermint, garlic/onion, coffee. Fruit flavors can be desirable and, if present, are present in a range of 2 g to 20 g per liter of product. Vanilla and other non-fruit oil flavorings can be used in a range of 2 g to 40 g per liter of product. For the chocolate flavoring, unsweetened cocoa powder can be used in a range of 40 g to 240 g per liter of product, more preferably 110 g to 130 g per liter of product.

Vanilla flavoring can be used in a range of 8 ml to 128 ml per liter of water, more preferably 16 ml to 112 ml per liter of water, and even more preferably 28 ml to 56 ml per liter of water. Coffee flavoring (coffee emulsion) can be used in a range of 1 ml to 48 ml per liter of water, more preferably 4 ml to 32 ml per liter of water, and even more preferably 8 ml to 16 ml per liter of water. Orange and other fruit flavorings can be used in a range of 1 ml to 48 ml per liter of water, more preferably 4 ml to 32 ml per liter of water, and even more preferably 10 ml to 20 ml per liter of water.

For a soup flavored gelled food product, the flavorings can include garlic powder, onion powder, celery powder, kale powder, and combinations thereof. Each of these powders can be present in a range of 0.8 g to 40 g per liter of water, more preferably 3 g to 24 g per liter of water, and even more preferably 4 g to 12 g per liter of water.

Different flavorings in the appropriate quantities to achieve the desired taste and color can be used in the gelled foods as long as there is no measurable increase of insulin in the blood. Powdered colorings and flavorings can be diluted with a small volume of water prior to addition to the mixture, to improve the uniform dispersion.

### Additives

Edible food additives can be present in the gelled foods disclosed herein. Unlimited examples include coloring, salt, weak acids, preservatives, pH balancers, mold inhibitors, or other compounds that do not stimulate insulin, nor interrupt ketosis

The salt can be table salt, such as NaCl or a potassium salt, such as KCl. Examples of weak acids include citric acid, acetic acid, malic acid, tartaric acid, and phosphoric acid. The weak acids can perform more than one function when present. For example, citric acid is a flavoring, a pH adjuster, a mold inhibitor, and a preservative, and folic acid is an essential nutrient and aids in vitamin B intake, is a pH adjuster, a mold inhibitor, and a preservative. Another example preservative is potassium sorbate.

In one embodiment, citric acid is present in the gelled food. Citric acid can be present in a range of 0.4 ml to 12 ml per liter of water, more preferably 0.8 ml to 4 ml per liter of water, and even more preferably in a range of 1.6 ml to 3.2 ml per liter of water. In one embodiment folic acid is present in the gelled food. Folic acid can be present in a range of 80 μg to 1600 μg per liter of water, more preferably 200 μg to 480 μg per liter of water, and even more preferably 240 μg to 400 μg per liter of water.

All the above ingredients and concentrations are useful in the “wet” gelled food, which is also the gelled food precursor for the dehydrated gelled food and the crisps, unless specifically indicated as being for the dehydrated gelled food or the crisps.

Turning again to FIGS. 4-6, the dehydrated gelled food has the thickening agent present in a range of 7 g to 40 g of a thickening agent per each liter of water, more preferably 12 g to 20 g of thickening agent per each liter of water, is dehydrated to a water content in a range of 40% to 70%, more preferably a water content in a range of 50% to 65%, and optionally includes a medium chain triglyceride (MCT) oil when the sweetener is present.

The MCT oil is typically made from coconut oil and/or palm kernel oil. The medium chain triglycerides typically comprise caprylic acid and capric acid. This is sometimes written as caprylic/capric triglycerides. With reference to coconut oil, the MCT oil is also known as fractionated coconut oil. Other oils that have a high concentration of MCT oil can be used as well. Some nonlimiting examples include avocado oil, and pumpkin seed oil, and combinations thereof. Olive oil can be used but only in certain food recipes due to its strong effect on flavor.

As discussed in detail in the working example herein, without MCT oil, the sweetener crystallizes on the exterior surface of the dehydrated gelled food as shown in FIG. 4. The crystals can provide the exterior surface with a scaley texture and an excessive sweetness. The addition of the MCT oil, depending upon its concentration, reduces the amount of sugar crystals on the exterior surface or eliminates them. See FIGS. 5 and 6, respectively. The concentration of MCT oil is in a range from 4 ml to 120 ml per liter of water, more preferably 12 ml to 80 ml per liter of water, and even more preferably 20 ml to 60 ml per liter of water.

Sweetener is desirable in the dehydrated form of the food product, which is why MCT oil is so beneficial therein. In some of the other food products, such as the crisps, since these are fried, no sweetener is present. “Unsweetened” as used herein describes those embodiments that have zero grams of sweetener present therein. Each food type disclosed herein can be unsweetened if desired but overall taste to the consumer should be considered. Vegetable oil is not desirable because of the overall health concerns presented by it.

Turning again to FIG. 7, with respect to the crisps, the gelled food precursor further includes baking soda. Baking soda is present in a range of 1 g to 24 g per liter of water, more preferably 4 g to 16 g per liter of water, and even more preferably 6 g to 12 g per liter of water. The baking soda provides an airiness to the crisps. The gelled food precursor for crisps may include a higher concentration of thickening agent. The thickening agent can present in a range of 12 g to 20 per liter of water.

The gelled food precursor is dehydrated to a water content of less than 20% and is thereafter fried to form a snack food with a crispy, airy texture. In one embodiment, the gelled food precursor is dehydrated until 85% to 95% of the water is removed. In one embodiment, the gelled food precursor is dehydrated until 90% to 95% of the water is removed. Thereafter, the dehydrated secondary precursor is fried to form a crisp.

Extensive graphing of blood glucose levels and blood ketone levels has been conducted by the Applicant for various individuals while fasting. Some are new to fasting and some are experienced with fasting, which alters how the body reacts to various foods and/or stimuli. The goal of fasting is to encourage the body to reach ketosis for fat metabolism to occur. An individual new to fasting may not reach ketosis even in a 20 hour fast. A graph of an individual of moderate experience with fasting evidenced that the body starting to overcome insulin resistance, but ketosis was minimal during a 10 day fast. This individual consumed a KETO food on day four of the fast as a lunch and a dinner. KETO foods are high fat, high protein foods that help the body return to ketosis faster that with carbs or sugars, but the graphing showed that the KETO foods significantly interfered with the individual's ketosis for the next 5 to 10 hours. KETO refers to ketogenic diet foods.

A more experienced faster (one that has nearly conquered their insulin resistance and has consistently high ketone metabolism as evidence by the graphing of the blood glucose levels and blood ketone levels) tested consumption of electrolytes without sweeteners. For this individual, experienced with fasting, the non-sweetened electrolytes did not significantly affect glucose or ketone levels. All individuals who used the electrolytes found the same results.

Another individual experienced with fasting tested consumption of herbal fruit teas without sweetener or sugar. The individual consumed tea at about 22 hours, 29 hours, 39 hours, 45 hours, 79 hours, 111 hours, and 131 hours. The graphing evidenced that the herbal fruit tea without sweetener or sugar elevated the blood glucose levels some for a short period of time and evidenced a significant disruption/interference of the individual's ketosis.

An experienced faster after reaching ketosis and at about the 65th hour of fasting held one white Tic Tac® (a brand of Ferrero an Italian company) in his mouth for 60 seconds. The graphing evidenced that the Tic Tac® caused a 33% drop in the individual's ketones and the blood glucose level went up around 12%. The percentage drop in ketones is well outside the margin of error and the blood glucose level was close to the margin of error for the blood meter being used.

In another test of stimuli, an individual experienced with fasting tested the effect of exercise on ketosis. Swimming, jogging, and even speed walking are each too much exercise while fasting and will inhibit ketosis. Three minutes of light jogging on a treadmill will inhibit ketosis during fasting. Another test conducted here was dry needle stimulation in the upper right deltoids, biceps, and triceps (upper arm and shoulder) on only the right arm. A 20 minute session of muscle stimulation as described was too much muscle stimulation, which interrupted the individual's ketosis. The individual's ketone level dropped about 31% (close to the same result as 60 seconds with a Tic Tac®). High intensity exercise will not only interfere with ketosis, but it will typically shut it off. The exercise may metabolize excess glucose in the body to avoid the glucose stored as fat, but almost no fat will be metabolized to create energy for the body during high intensity exercise.

Now, turning to the gelled food products disclosed herein and shown in FIGS. 1-7, an individual experienced with fasting consumed four of the “dots” gelled foods at about 46 hours, four more “dots” gelled food product at 47 hours, four more dots at 47 hours 35 minutes, and then a gelled food cup product at 48 hours 40 minutes, and their blood glucose levels did not go up and not only did ketosis not get interrupted, blood ketones levels continued to rise. In other words, the fasting process was not interrupted by consumption of the gelled food products. The individual again consumed some of the gelled food products—one “dot” at 57 hours and a gelled food cup product at 65 hours. Again, there was no detectable rise in the blood glucose level and the ketones continued to rise for uninterrupted fasting.

Black or green tea, black coffee, and water can be consumed during fasting without interfering with ketosis. Almost anything else will interrupt ketosis. Even exercise (cortisol) drastically interferes with ketosis. Fight or flight hormones will interrupt ketosis. Keto foods, as discussed above, often contain carbohydrates and will prevent ketosis levels desired during fasting. Yet, the gelled food products disclosed herein can be consumed during fasting and do not interfere with ketosis.

The following examples further illustrate the invention but should not be construed as in any way limiting its scope. Considering the present disclosure and the general level of skill in the art, those of skill will appreciate that the following Examples are intended to be exemplary only and that numerous changes, modifications, and alterations can be employed without departing from the scope of the presently disclosed subject matter.

### Working Example 1

“Wet” form of FIGS. 1 and 2.

TABLE 1

| Name | Amount | |
|---|---|---|
| Water | 250 | ml |
| Agar | 1.75 | g |
| Salt | 0.5 | g |
| Monk fruit Sweetener | 45 | g |
| Orange oil | 2.5 | ml |
| Vanilla extract | 1.25 | ml |
| Citric acid | 0.5 | g |
| Folic acid | 80 | Mcg |

The agar, salt, and monk fruit sweetener were mixed together at room temperature (25° C.). The mixture was heated slowly while stirring to the activation temperature of the agar (100° C.). When the mixture reached 100° C., the mixture was maintained at this temperature for three and half to four minutes, with stirring and monitoring so as not to boil over. The citric acid, orange oil, and vanilla extract was added with mixing. The folic acid was added with mixing. The resulting mixture was poured in a measuring cup and water was added to make up for the water evaporated during the boiling process, up to 250 ml, with mixing. The mixture was poured into the cups shown in FIG. 1 and a lid was placed on each cup while the mixture was above the setting temperature of the agar (about 40° C.). The cups were refrigerated until the mixture “hardened.” (The mixture will harden when left at room temperature, but it is faster if refrigerated.) A gelled food was formed that would hold its shape when removed from the container, as seen in FIG. 2.

### Working Example 2

“Dots” as shown in FIG. 3.

TABLE 2

| Name | Amount | |
|---|---|---|
| Water | 250 | ml |
| Agar | 3.5 | g |
| Salt | 1 | g |
| Monk fruit Sweetener | 2.5 | g |
| Garlic powder | 2 | g |
| Celery powder | 1.5 | g |
| Onion powder | 1 | g |
| Kale powder | 0.8 | g |
| Citric acid | 0.4 | g |
| Folic acid | 80 | Mcg |

The agar, salt, monk fruit sweetener, garlic powder, onion powder, celery powder, and kale powder were mixed at room temperature (25° C.). The mixture was heated slowly while stirring to the activation temperature of the agar (100° C.). When the mixture reached 100° C., the mixture was maintained at this temperature for three and half to four minutes, with stirring and monitoring so as not to boil over. The citric acid was added with mixing. The folic acid was added with mixing. The resulting mixture was poured in a measuring cup and room temperature water was added, as necessary, to make up for the water evaporated during the boiling process, up to 250 ml, with mixing. The mixture was poured into flat, round molds having a diameter of 2.5 cm and 1.2 cm in height, while the mixture was above the setting temperature of the agar (about 40° C.). The molds were refrigerated until the mixture “hardened.” A gelled food was formed that would hold its shape when removed from a mold, as seen in FIG. 3.

### Working Example 3

A dehydrated form as shown in FIGS. 4 to 6.

TABLE 3

| | Trial 1 | | Trial 2 | | Trail 3 | |
|---|---|---|---|---|---|---|
| Name | Amount | | Amount | | Amount | |
| Water | 250 | ml | 250 | ml | 250 | ml |
| Agar | 1.75 | g | 1.75 | g | 1.75 | g |
| Salt | 0.6 | g | 0.6 | g | 0.6 | g |
| Monk fruit Sweetener | 45 | g | 45 | g | 45 | g |
| Cocoa powder | 30 | g | 30 | g | 30 | g |
| Vanilla Extract | 14 | ml | 14 | ml | 14 | ml |
| Coffee emulsion | 4 | ml | 4 | ml | 4 | ml |
| MCT oil | — | | 5 | ml | 10 | ml |
| Folic acid | 60 | Mcg | 60 | Mcg | 60 | Mcg |

The agar, salt, monk fruit sweetener, and cocoa powder were mixed at room temperature (25° C.). The mixture was heated slowly with stirring to an activation temperature of the agar (100° C.). When the mixture reached 100° C., the mixture was maintained at this temperature for three and half to four minutes, with stirring and monitoring so as not to boil over its container. The vanilla extract, coffee emulsion, and MCT oil were added with mixing. The folic acid was added with mixing. The resulting mixture was poured in a measuring cup and water was added, as necessary, to make up for the water evaporated during the boiling process, up to 250 ml, with mixing. The mixture was poured into molds of 4.5 cm×3.6 cm×1.5 cm while the mixture was above the setting temperature of the agar (about 40° C.). The molds were refrigerated until the mixture “hardened” to form a gelled food.

Next, the gelled food was dehydrated to remove 55% to 70% of the water. In the given instance, approximately 60% of the water content was removed and the temperature of the environment was maintained at 70° C.

Trial 1 corresponds to FIG. 4 in which there is no MCT oil added to the composition. With no MCT oil present, a scaly surface of crystallized sweetener formed on the exterior surface of the dehydrated gelled food. Additionally, the middle of the dehydrated gelled food was denser than those of Trial 1 and 2 shown in FIGS. 5 and 6.

Turning now to FIG. 5, corresponding to Trial 2, the gelled food precursor comprised 5 ml of MCT oil (2% w/w) and a light crystallized powdered surface appeared on the exterior of the dehydrated gelled food.

Turning now to FIG. 6, corresponding to Trial 3, the gelled food precursor comprised 10 ml of MCT oil (4% w/w) and the exterior surface of the dehydrated gelled food has a matte-like finish to the exterior surface.

The surface texture shown in FIG. 4 with no MCT oil present in the composition was generally undesirable in texture and in the initial taste of excessive sweetness when consumed. The amount of crystallization can be tailored by varying the amount of MCT oil present. It was found that MCT oil in a range of 5 to 15 ml in the formulation of Table 3 provided a reasonably desirable texture and sweetness as well as overall density to the body of the gelled food product shown.

### Working Example 4

A dehydrated and fried form as shown in FIG. 7.

TABLE 4

| | |
|---|---|
| Trail 4 | Trial 5 |

| | | |
|---|---|---|
| Name | Amount | Amount |

| Water | 250 | ml | 250 | ml |
|---|---|---|---|---|
| Agar | 3.5 | g | 3.5 | g |
| Salt | 1 | g | 0.6 | g |
| Monk fruit Sweetener | 2.5 | g | — | |
| Garlic powder | 2 | g | 2 | g |
| Celery powder | 1.5 | g | 2.8 | g |
| Onion powder | 1 | g | 1 | g |
| Kale powder | 0.8 | g | — | |
| Phylum powder | | | 4 | g |
| Chia powder | | | 2.5 | g |
| Citric acid | 0.4 | g | 0.4 | g |
| Folic acid | 80 | Mcg | 80 | Mcg |
| Baking soda | 1.5 | g | 1.5 | g |

The agar, salt, garlic powder, onion powder, celery powder, and kale powder (of Trial 4) or the agar, salt, garlic powder, onion powder, celery powder, phylum powder, and chia powder (of Trial 5) are mixed at room temperature or cold water. The mixture was heated slowly while stirring to the activation temperature of the Agar (100° C.). When the mixture reached 100° C., the mixture was boiled at this temperature for three and half to four minutes, with stirring and monitoring the bubbling to avoid boiling over. The heat was turned off and the citric acid was added with mixing. The baking powder was added with mixing. When the baking powder was added there was a chemical reaction resulting in foaming and bubbling up of the mixture. The folic acid was added with mixing. The resulting mixture was left to rest for 2 to 4 minutes to allow the foam to dissipate. The resulting mixture was stirred, and water was added to maintain a volume of 250 ml. The mixture was poured into a flat tray to a depth of 3 mm to 4 mm while the mixture was above the setting temperature of the Agar (about 40° C.) and was left to settle at room temperature for 3-5 minutes in order to maintain the thickness of the pour. The tray was placed in the refrigerator to continue hardening for at least 5 minutes. Then, the gelled food was cut into 3 cm by 3.5 cm rectangles.

The rectangular pieces of gelled food were dehydrated to remove 85% to 95% of the water.

The average water loss for crisps made and tested was consistently between 93% and 94%. The average water loss for the ten crisps listed in Table 5 below is 93.6%.

TABLE 5

| | “Wet” form | Crisp | |
|---|---|---|---|
| | (g) | (g) | % water loss |
| 1 | 8.834 | 0.556 | 93.70 |
| 2 | 12.811 | 0.806 | 93.70 |
| 3 | 10.181 | 0.641 | 93.70 |
| 4 | 11.868 | 0.744 | 93.73 |
| 5 | 10.433 | 0.654 | 93.73 |
| 6 | 13.209 | 0.864 | 93.45 |
| 7 | 12.343 | 0.809 | 93.44 |
| 8 | 8.000 | 0.516 | 93.55 |
| 9 | 9.183 | 0.578 | 93.70 |
| 10 | 9.772 | 0.617 | 93.68 |

Then, the dehydrated pieces were processed to form a puffed food product, i.e., air pockets form to render the food product airy and typically, crunchy.

One option for puffing the dehydrated pieces is to fry them in oil (olive oil was used in the experiments but is not limited thereto) at a temperature between 176° C. to 188° C. for 5 to 10 seconds. When fried, the pieces expand and become airy and crunchy, i.e., crisps are formed as shown in FIG. 7. Lastly and optionally, the fried pieces were placed in the dehydrator for a secondary dehydration (post-frying dehydration) for 1 hour at 70° C. It was observed that after the secondary dehydration, the oiliness of the crisps decreased, and the crispiness increased.

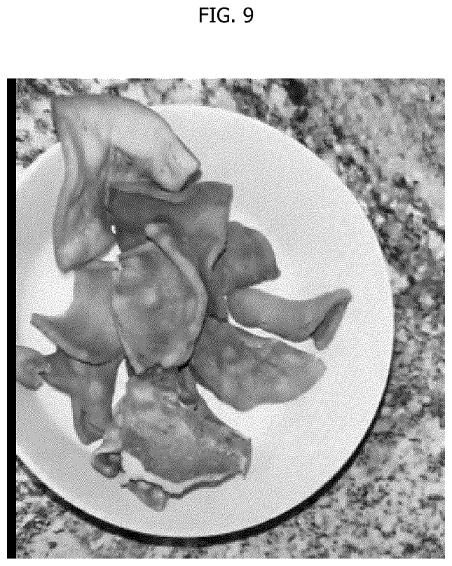

Another option for puffing the dehydrated pieces is to heat them in an air fryer. Applicant did not think heating the dehydrated pieces in the air fryer in the absence of oil would cause the dehydrated foods to puff and crisp. The dehydrated pieces did indeed puff as shown by the time lapse flowchart of photographs in FIG. 8 to produce the crisps shown in FIG. 9. The batch shown in FIGS. 8 and 9 was placed in an air fryer at a temperature of 350° F. for six minutes. The air fryer is typically pre-heated to the selected temperature, which can be in a range of 200° F. to 400° F., more preferably 300° F. to 375° F. The dehydrated pieces can be in the air fryer at a selected temperature for a time sufficient to complete the desired puffing thereof, typically in a range of 2 minutes to 10 minutes.

Other commercially available or hereinafter developed puffing equipment can be used to “puff” the dehydrated pieces made herein. Sometimes puffing equipment can be referred to as “popping” equipment, which is also included herein.

### Working Example 5

Fasting Insulin Test-A measurement of the insulin levels in the blood after at least 8 hours of fasting. The test can be accomplished by a blood sample taken by a healthcare professional. The normal range of fasting insulin in the blood varies somewhat between labs but is in a range of around 2 to 10 mIU/ml (milli-international units per milliliter). The margin of error for laboratory testing methods is in excess of 2 mIU/ml. Consumer blood meters used in home tests, have a minimum margin of error of 10% and can be as much as +/−25%. Typical insulin levels for a person who is fasting are 2 to 10 mIU/ml and 30 to 230 mIU/ml after meals. A measurement of 2 mIU/ml is considered the minimum amount possible in a healthy human.

An individual, on day four of an extended fast, had blood drawn at a hospital laboratory to test his insulin level before and after consuming food products. The fasting level of insulin measured 3.0 mIU/ml. Thereafter, the individual consumed 2 gelled food cups, such as shown in FIG. 1, and 8 dots, such as shown in FIG. 2. Ninety minutes after consumption of the gelled food cups and the dots, the post-consumption blood insulin draw was conducted. The post-consumption insulin level measured 4.0 mIU/ml. For the equipment used, i.e., its margin of error, the increase of 1 mIU/ml is essentially “no change.” The value is still well within the normal insulin range for a person who is fasting.

### Methods for Making

Any of the gelled food precursors can be made by mixing a gelling agent and water and heating with continuous mixing. It is preferable to heat the mixture slowly to a temperature above the activation temperature above that of the gelling agent, for example heating to about 100° C. A flavoring agent, a sweetener (optional), and any other selected additive can be added to the agar and water mixture before heating or during heating. After heating for several minutes at the 100° C. (at boiling) with stirring, the mixture was poured into a measuring device and the volume was adjusted by addition of water to replace any water lost due to evaporation. For example, if the batch was made using a 1000 ml of water, the total volume was brought back up to 1000 ml. After the volume is adjusted, the mixture is poured into molds, pans, or any the like to cool and set to a desired shape or thickness. The cooling can occur at room temperature or in a reduced temperature environment for a shorter time until set. A refrigerator or cooler can be set at a temperature in a range of 1° C. to 10° C.

The method can involve dissolving or diluting colorings and/or flavorings in a volume of water before addition to the mixture discussed above. This can improve the uniformity of dispersion thereof in the mixture. If citric acid is to be present in the mixture, it can be added to the agar and water before heating begins or after the mixture has been boiled for the preselected period of time.

To make a dehydrated food product, the gelled food product is made as discussed above, with the addition of less water after cooking, and after it is set, the water is removed by any suitable method to form a partially dehydrated food product comprising a water content of 30% w/w to 45% w/w thereof. The removal of water can be achieved at ambient room conditions, exposure to wind, exposure to heat, exposure to sunshine, placement in a dehydrator, or any combination thereof. In one embodiment, a dehydrator is used, which is set to a temperature in a range of 60° C. to 77° C. The amount of time the food is in the dehydrator is dependent on the starting water content, the temperature of the dehydrator, and the desired food product. In particular, the shape selected for the food precursor can be a factor effecting the time required to dehydrate the food product to the desired water content. But all shapes, given enough time at a controlled, preselected temperature will dehydrate.

The thickening agent and the sweetener can be any of those discussed above. The flavor possibilities are endless, only limited by avoiding flavors that would cause an insulin spike.

If a crisp food product is desired, the method involves making the gelled food product as discussed above, however baking soda is present and the sweetener is significantly reduced or can be omitted, removing water therefrom to form a dehydrated food product having a water content of 10% w/w or less, and then puffing or popping the dehydrated food product to form a crisp food product. For the crips food products, the food precursor, just prior to puffing or popping, preferably has a thickness of 5 mm or less. If the puffing/pooping process involved frying in oil, the fried food product can optionally be dehydrated a second time to help remove or reduce the oily texture. The frying comprises frying in an oil selected form the group consisting of coconut oil, olive oil, avocado oil, and pumpkin seed oil. Frying does not use processed oils or processed grain seed oil, including vegetable oil because these oil include substances that will cause an insulin spike or increase blood glucose levels, which is undesirable for the intended use of these products. However, if the food product is meant as a general snack food for any consumer, i.e., one not fasting, any oil could be used.

It should be noted that the embodiments are not limited in their application or use to the details of construction and arrangement of parts and steps illustrated in the drawings and description. Features of the illustrative embodiments, constructions, and variants may be implemented or incorporated in other embodiments, constructions, variants, and modifications, and may be practiced or carried out in various ways. Furthermore, unless otherwise indicated, the terms and expressions employed herein have been chosen for the purpose of describing the illustrative embodiments of the present invention for the convenience of the reader and are not for the purpose of limiting the invention.

Having described the invention in detail and by reference to preferred embodiments thereof, it will be apparent that modifications and variations are possible without departing from the scope of the invention which is defined in the appended claims.

What is claimed is:

1. A method of making a food product, the method comprising:
providing a gelled food product comprising 1 g to 40 g of a thickening agent per liter of water, a medium chain triglyceride oil, and a flavoring, wherein the thickening agent, sweetener, water, and flavoring do not produce an insulin spike or increased blood glucose level upon consumption; and
removing water from the gelled food product to form a partially dehydrated food product comprising a water content of 30% w/w to 45% w/w thereof.

2. The method of claim 1, wherein removing water occurs in maximum of 10 hours.

3. The method of claim 1, wherein removing the water comprises placing the gelled food product in a dehydrator at a temperature of 60° C. to 77° C.

4. The method of claim 1, wherein the thickening agent is selected from the group consisting of agar-agar, Kanten, locust bean gum, Xanthan gum, gum Arabic, acacia gum, konjac, pectin, alginate, arabinoxylan, cassia gum, cellulose, arrowroot, kudzu, marshmallow root, beta-glucan, curdlan, and combinations thereof.

5. The method of claim 1, wherein the gelled food product further comprises a sweetener.

6. The method of claim 5, wherein the sweetener is a natural sweetener selected from the group consisting of monk fruit sweetener, stevia, erythritol, xylitol, and combinations thereof.

7. A method of making a food product comprising:
providing a gelled food product comprising 1 g to 40 g of a thickening agent per liter of water, baking soda, and a flavoring, wherein the thickening agent, baking soda, water, and flavoring do not produce an insulin spike or increased blood glucose level upon consumption; and
removing water from the gelled food product to form a dehydrated food product having a water content 10% w/w or less thereof;
puffing or popping the dehydrated food product to form a crisp food product.

8. The method of claim 7, wherein puffing or popping comprises frying in an oil selected form the group consisting of coconut oil, olive oil, avocado oil, and pumpkin seed oil.

9. The method of claim 8, further comprising secondarily dehydrating the crisp food product.

10. The method of claim 7, wherein puffing or popping comprises air frying the dehydrated food form.
